(19) United States
(12) Patent Application Publication
(10) Pub. No.: US 2015/0149384 A1
(43) Pub. Date: May 28, 2015

(54) METHOD AND SYSTEM FOR DISPLAYING INFORMATION AND COMPUTER READABLE MEDIUM

(71) Applicant: TENCENT TECHNOLOGY (SHENZHEN) COMPANY LIMITED, Shenzhen, Guangdong (CN)

(72) Inventor: Bin Zhou, Shenzhen (CN)

(21) Appl. No.: 14/405,617

(22) PCT Filed: Jun. 4, 2013
(86) PCT No.: PCT/CN2013/076736

§ 371 Date: Dec. 4, 2014

(30) Foreign Application Priority Data
Jun. 6, 2012 (CN) 201210184759.0

(51) Int. Cl. G06Q 30/02; G06F 3/0484

(52) U.S. Cl. CPC G06Q 30/0282; G06F 3/04842
USPC 705/347

(57) ABSTRACT

Disclosed is a method for displaying information, including: receiving and storing a manner for acquiring user assessment information of a product; when published information of the product is exhibited, after a mouse hover event is detected, acquiring the user assessment information of the product according to manner for acquiring the user assessment information of the product; and displaying the user assessment information of the product. The disclosure further provides a system for displaying information and computer readable medium. By means of the present disclosure, the click-through rate and conversion rate of the published information can be improved.

### CROSS-REFERENCE TO RELATED PATENT APPLICATIONS

This application claims the priority of Chinese Patent Application No. 201210184759.0 filed on Jun. 6, 2012 and entitled “METHOD AND SYSTEM FOR DISPLAYING INFORMATION” by Tencent Technology (Shenzhen) Co., Ltd., the content of which is incorporated herein by reference in its entirety.

### TECHNICAL FIELD

The present disclosure relates to the field of Internet applications, and in particular to a method and system for displaying information and a computer readable medium.

### BACKGROUND

Publishing information on the Internet is a way of propagation, a product manufacturer can propagate its own brands or promote its own products by publishing information, an Internet service provider can charge the product manufacturer to maintain operation, and thus can provide users with free services, a minority of of the users can acquire desirable information content by publishing information. However, the current exhibition form of published information on the Internet makes a user easily neglect indirect benefits to himself/herself getting from publishing information, while users getting benefits directly from publishing information are very few, this makes users consider that published information is somehow a harassment, which severely impacts user experiences, thereby making the value of browsing published information lowered.

### SUMMARY

In view of the above, the present disclosure are intended to provide a method and system for displaying information and computer readable medium, which can improve the click-through rate and conversion rate of published information.

Therefore, the technical solutions of the present disclosure are implemented as follows.

The embodiments of the present disclosure provide a method for displaying information, and the method includes:

a manner for acquiring user assessment information of a product is received and stored;

when published information is exhibited, after a mouse hover event is detected, user assessment information of the product is acquired according to the manner for acquiring user assessment information of the product; and

the user assessment information of the product is displayed.

The embodiments of the present disclosure further provides a system for displaying information, and the system includes a delivery system, a front-end controller and an information database, wherein

the delivery system is configured to receive and store a manner for acquiring user assessment information of a product;

the front-end controller is configured to: when published information is exhibited, after a mouse hover event is detected, acquire user assessment information of the product according to the manner for acquiring user assessment information of the product; and display the user assessment information of the product; and

the information database is configured to store the user assessment information of the product.

The embodiments of the present disclosure further provides a computer readable medium, in which a computer-executable instruction is stored, wherein the computer-executable instruction is configured to implement the aforementioned method for displaying information.

In the method and system for displaying information and the computer readable medium, a manner for acquiring user assessment information of a product is received and stored; when published information is exhibited, after a mouse hover event is detected, user assessment information of the product is acquired according to the manner for acquiring user assessment information of the product; and the user assessment information of the product is displayed. In this way, when a user's mouse stops at published information, user assessment information of a product corresponding to the published information will be provided to the user, then the user can check the user assessment of the product in time in such a way that the information can be checked simply, conveniently and flexibly, thereby improving the click-through rate and conversion rate of the published information.

### BRIEF DESCRIPTION OF THE DRAWINGS

FIG. 1 is a schematic flow chart of a method for displaying information implemented by the present disclosure; and

FIG. 2 is a schematic structural diagram of a system for displaying information implemented by the present disclosure.

### DETAILED DESCRIPTION

The basic ideas of the embodiments of the present disclosure lie in: a manner for acquiring user assessment information of a product is received and stored; when published information is exhibited, after a mouse hover event is detected, user assessment information of the product is acquired according to the manner for acquiring user assessment information of the product; and the user assessment information of the product is displayed.

The present disclosure will be further elaborated below in combination with the accompanying drawings and specific embodiments.

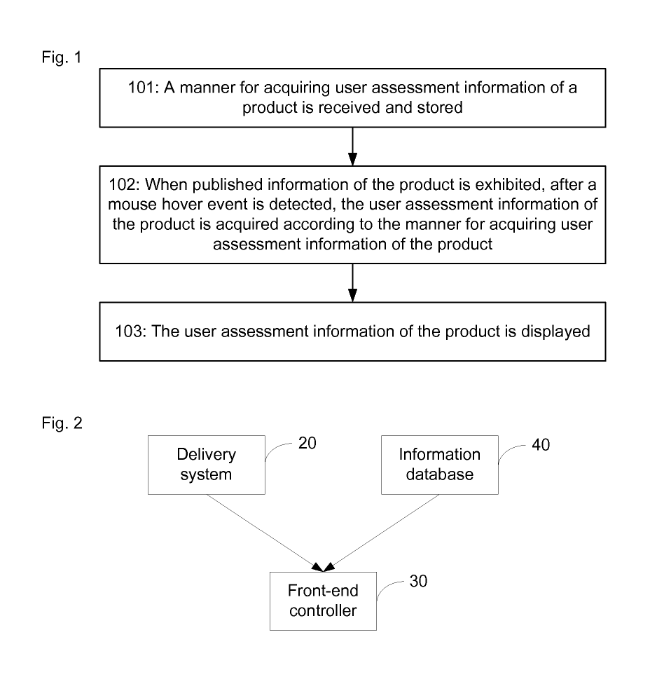

The embodiments of the present disclosure provides a method for indicating information, FIG. 1 is a schematic structural diagram of a method for displaying information implemented by the present disclosure, as shown in FIG. 1, the method includes the following steps.

Step 101, a manner for acquiring user assessment information of a product is received and stored;

Specifically, a manufacturer of a product may upload published information and a jump address to a delivery system of the published information, in this present disclosure, it is further desirable to provide the delivery system with a manner for acquiring user assessment information of the product; the delivery system receives and stores published information and the jump address of the product and the manner for acquiring user assessment information of the product; wherein the manner for acquiring user assessment information of the product may be calling an interface provided by the manufacturer or calling a link address provided by the manufacturer by means of a URL request, i.e., the user assessment information of the product can be acquired by calling a provided interface or calling a provided link address by means of a URL request; the user assessment information of the product refers to related assessment made on the product by a user after buying the product, for example, assessment information made by a QQ friend, weibo friend and the like of a visitor of published information after buying a product is that the quality of the product is good, alternatively, other buyers find after buying the product that the product has a quality problem, and he/she will stated it in the assessment information in time, thus a visitor of the published information can conveniently choose whether to buy the product or not according to genuine user assessment information of the product.

Step 102, when published information of the product is exhibited, after a mouse hover event is detected, the user assessment information of the product is acquired according to the manner for acquiring of user assessment information of the product;

Specifically, a front-end controller acquires from the delivery system published information of a product desired to be exhibited, and exhibits the published information of the product in an exhibition area of the published information in a browser or an Internet application; in practical applications, the front-end controller can be implemented by a scripting language program such as a JaveScript program, in which there is a response function of a mouse hover event, so that during the exhibition of the published information by the front-end controller, if a mouse enters into the exhibition area of the published information, the front-end controller can then detect the mouse hover event, the front-end controller detecting the mouse hover event acquires from the delivery system the manner for acquiring of the user assessment information of the product, based on which the front-end controller calls an interface or calls a link address by means of a URL request, and acquires from an information database of the product the assessment information of the product; the information database is configured to store and maintain user assessment information of a product and provide the user assessment information to a front-end controller as needed.

Step 103, the user assessment information of the product is displayed;

Specifically, during an exhibition of the published information of the product, if the front-end controller detects a mouse hover event, it is desired to acquire user assessment information of the product, and display the user assessment information of the product; here the displaying mode may include: displaying the user assessment information of the product below the exhibition area of the published information in a rolling mode, or suspending the user assessment information of the product over the published information with the published information as a background; when the mouse moves out of the exhibition area of the published information, the front-end controller will cancel an operation of displaying user assessment information of a product, and the displayed user assessment information will disappear. In this way, when a user's mouse stops at published information, user assessment information of a product corresponding to the published information will be provided to the user, then the user can check the user assessment of the product in time in such a way that the information can be checked simply, conveniently and flexibly, thereby improving the click-through rate and conversion rate of the published information.

To implement the above method, the present disclosure further provides a system for displaying information, FIG. 2 is a schematic structural diagram of a system for displaying information implemented by the present disclosure, as shown in FIG. 2, the system includes a delivery system 20, a front-end controller 30 and an information database 40, wherein

the delivery system 20 is configured to receive and store a manner for acquiring user assessment information of a product;

the front-end controller 30 is configured to: when published information is exhibited, after a mouse hover event is detected, acquire user assessment information of the product according to the manner for acquiring user assessment information of the product; and display the user assessment information of the product; and

the information database 40 is configured to store the user assessment information of the product.

Wherein the receiving and storing, by the delivery system 20, a manner for acquiring user assessment information of a product includes: the delivery system receives and stores published information of a product and a manner for acquiring user information of the product; the manner for acquiring the user information includes calling an interface or calling a link address by means of a URL request.

Wherein the acquiring, by the front-end controller 30, the user assessment information according to the manner for acquiring user assessment information of the product includes: when a front-end controller exhibits the published information, if a mouse moves into an exhibition area of the published information, the front-end controller detects the mouse hover event, acquires from the delivery system the manner for acquiring user assessment information of the product, and acquires from an information database of the product the user assessment information of the product according to the manner for acquiring user assessment information of the product.

Wherein the displaying, by the front-end controller 30, the user assessment information of the product includes: after detecting the mouse hover event and acquires the user assessment information of the products, the front-end controller displays the user assessment information of the product below the exhibition area of the published information in a rolling mode, or suspends the user assessment information of the product over the published information with the published information as a background.

Wherein the front-end controller 30 is further configured to: when the mouse moves out of the exhibition area of the published information, cancel an operation of displaying the user assessment information of the product, thereby displayed user assessment information disappears.

If the integrated modules as described by the embodiments of the present disclosure are implemented by a software functional module and sold or used as a separate product, it may also be stored in a computer-readable medium. Based on such an understanding, the technical solutions according to embodiments of the present disclosure in essence or the part contributing to the prior art can be embodied in the form of a software product, and the computer software product is stored in a computer-readable medium, which includes several instructions so that a computer device (may be a personal computer, a server, a network device or the like) implements all or part of the method according to respective embodiments of the present disclosure. The aforementioned computer-readable medium may include various media capable of storing program codes, such as a USB disk, a mobile HDD, a Read-Only Memory (ROM), a Random Access Memory (RAM), a magnetic disk, an optical disk or the like. In this way, the embodiments of the present disclosure are not limited to any specific combination of a hardware and a software.

Correspondingly, the embodiments of the present disclosure further provides a computer readable medium, in which a computer-executable instruction is stored, wherein the computer-executable instruction is configured to implement the method for displaying information according to the embodiments of the present disclosure.

What described are merely preferable embodiments of the present disclosure, and are not intended to limit the present disclosure. All modifications, replacements and improvements made within the spirit and principles of the present disclosure should be included within the scope of protection of the present disclosure.

1. A method for displaying information, comprising:
receiving and storing a manner for acquiring user assessment information of a product;
when published information of the product is exhibited, after a mouse hover event is detected, acquiring the user assessment information of the product according to the manner for acquiring the user assessment information of the product; and
displaying the user assessment information of the product.

2. The method according to claim 1, wherein the step of receiving and storing a manner for acquiring user assessment information of a product comprises:
receiving and storing, by a delivery system, the published information of the product and the manner for acquiring the user assessment information of the product;
the manner for acquiring the user assessment information comprising calling an interface or calling a link address by means of a URL request.

3. The method according to claim 2, wherein the step of acquiring the user assessment information of the product according to the manner for acquiring the user assessment information of the product comprises:
when a front-end controller exhibits the published information, if a mouse moves into an exhibition area of the published information, detecting, by the front-end controller, the mouse hover event, acquiring from the delivery system the manner for acquiring the user assessment information of the product, and acquiring from an information database of the product the user assessment information of the product according to the manner for acquiring the user assessment information of the product.

4. The method according to claim 3, wherein the step of displaying the user assessment information of the product comprises:
after the front-end controller detects the mouse hover event and acquires the user assessment information of the product, displaying the user assessment information of the product below the exhibition area of the published information in a rolling mode, or suspending the user assessment information of the product over the published information with the published information as a background.

5. The method according to claim 4, further comprising:
when the mouse moves out of the exhibition area of the published information, cancelling, by the front-end controller, an operation of displaying the user assessment information of the product, thereby the displayed user assessment information disappears.

6. A system for displaying information, comprising a delivery system, a front-end controller and an information database, wherein
the delivery system is configured to receive and store a manner for acquiring user assessment information of a product;
the front-end controller is configured to: when published information of the product is exhibited, after a mouse hover event is detected, acquire the user assessment information of the product according to the manner for acquiring the user assessment information of the product; and display the user assessment information of the product; and
the information database is configured to store the user assessment information of the product.

7. The system according to claim 6, wherein the delivery system receiving and storing a manner for acquiring user assessment information of a product comprises:
the delivery system receives and stores the published information of the product and the manner for acquiring the user assessment information of the product; and
wherein the manner for acquiring the user assessment information comprises calling an interface or calling a link address by means of a URL request.

8. The system according to claim 7, wherein the front-end controller acquiring the user assessment information of the product according to the manner for acquiring the user assessment information of the product comprises:
when a front-end controller exhibits the published information, if a mouse moves into an exhibition area of the published information, detecting, by the front-end controller, the mouse hover event, acquiring from the delivery system the manner for acquiring the user assessment information of the product, and acquiring from an information database of the product the user assessment information of the product according to the manner for acquiring the user assessment information of the product.

9. The system according to claim 8, wherein the front-end controller displaying the user assessment information of the product comprises:
after the front-end controller detects the mouse hover event and acquires the user assessment information of the product, displaying the user assessment information of the product below the exhibition area of the published information in a rolling mode, or suspending the user assessment information of the product over the published information with the published information as a background.

10. The system according to claim 9, wherein the front-end controller is further configured to, when the mouse moves out of the exhibition area of the published information, cancel an operation of displaying the user assessment information of the product, thereby the displayed user assessment information disappears.

11. A non-transitory computer-readable storage medium with computer-executable instructions stored thereon, the computer-executable instructions are executable for:
receiving and storing a manner for acquiring user assessment information of a product;
when published information of the product is exhibited, after a mouse hover event is detected, acquiring the user assessment information of the product according to the manner for acquiring the user assessment information of the product; and
displaying the user assessment information of the product.

12. The non-transitory computer-readable storage medium according to claim 11, the computer-executable instructions are executable for:
receiving and storing, by a delivery system, the published information of the product and the manner for acquiring the user assessment information of the product;
the manner for acquiring the user assessment information comprising calling an interface or calling a link address by means of a URL request.

13. The non-transitory computer-readable storage medium according to claim 12, the computer-executable instructions are executable for:
when a front-end controller exhibits the published information, if a mouse moves into an exhibition area of the published information, detecting, by the front-end controller, the mouse hover event, acquiring from the delivery system the manner for acquiring the user assessment information of the product, and acquiring from an information database of the product the user assessment information of the product according to the manner for acquiring the user assessment information of the product.

14. The non-transitory computer-readable storage medium according to claim 13, the computer-executable instructions are executable for:
after the front-end controller detects the mouse hover event and acquires the user assessment information of the product, displaying the user assessment information of the product below the exhibition area of the published information in a rolling mode, or suspending the user assessment information of the product over the published information with the published information as a background.

15. The non-transitory computer-readable storage medium according to claim 14, the computer-executable instructions are executable for:
when the mouse moves out of the exhibition area of the published information, cancelling, by the front-end controller, an operation of displaying the user assessment information of the product, thereby the displayed user assessment information disappears.
